(19) United States
(12) Patent Application Publication
(10) Pub. No.: US 2016/0110475 A1
(43) Pub. Date: Apr. 21, 2016

(54) Method and System of Determining Transitive Closure

(71) Applicant: PERVASIVE HEALTH, INC., Chicago, IL (US)

(72) Inventors: James LATHAM, Bristol (GB); Michael OLTMAN, Chicago, IL (US)

(21) Appl. No.: 14/894,288

(22) PCT Filed: May 28, 2014
(86) PCT No.: PCT/US2014/039769

§ 371 Date: Nov. 25, 2015

Related U.S. Application Data
(60) Provisional application No. 61/828,042, filed on May 28, 2013.

(51) Int. Cl. G06F 17/30

(52) U.S. Cl. CPC G06F 17/30958; G06F 17/30324

(57) ABSTRACT

A method for determining paths from a first vertex and a second vertex in an acyclic directed graph comprises determining a plurality of paths from one or more root vertices in the graph to one or more leaf vertices in the graph, storing each of the plurality of paths as a respective array in a computer database, each respective array comprising a respective root, a respective leaf, and up to a plurality of intermediate vertices, and determining whether the first vertex and the second vertex are both represented in one or more of the arrays.

### CROSS-REFERENCE TO RELATED APPLICATION

This application claims the benefit of U.S. provisional application No. 61/828,042, filed May 28, 2013, now pending.

### BACKGROUND

a. Technical Field

The instant disclosure relates to the representation, storage, and retrieval of data represented by a directed acyclic graph with a computer database.

b. Background Art

Many data collections are systematically organized and may be represented using graphs constructed of vertices containing information and edges that represent the relationships between the vertices. These include clinical ontologies, such as SNOMED-CT, that are large and complex with hundreds of thousands of concepts linked by over a million relationships of many different types. Storing such ontologies in a database suitable for computing is a significant technical challenge.

One of the most common computing problems for graphs is to determine the existence of a path between vertices. This is known as the transitive closure problem. Research efforts have described solutions to the transitive closure problem with varying efficiency in terms of memory and processing required. Examples are the Warshall procedure that uses nested loops to build a transitive closure matrix or solutions using relational databases and SQL.

Known systems using SQL generally store each relationship in a graph (i.e., between connected vertices, or between a vertex and itself) as a separate row in an SQL table. One such known SQL system is shown in U.S. Pat. No. 5,819,257, which is hereby incorporated by reference as though fully set forth herein.

### SUMMARY

Known methods for storing the transitive closure of a directed acyclic graph and for interacting with the data represented by the graph are inefficient and can be improved upon. In particular, known methods for determining a path including a given set of vertices, such as a first vertex and a second vertex, may be improved upon. An exemplary method that improves on known methods may include determining a plurality of paths from one or more root vertices in the graph to one or more leaf vertices in the graph and storing each of the plurality of paths as a respective array in a computer database. Each respective array may comprise a respective root, a respective leaf, and up to a plurality of intermediate vertices. The method may further include determining whether the first vertex and the second vertex are both represented in one or more of the arrays. Such an array-based method may be implemented with a declarative programming language, and may be more efficient for determining paths between vertices (including intermediate vertices) than known methods, especially known methods based on SQL tables. In particular, the method may enable more efficient determination of paths including any number of vertices, especially paths including three or more given vertices.

### BRIEF DESCRIPTION OF THE DRAWINGS

FIG. 1 is a flow chart illustrating an exemplary method of determining transitive closure between a first vertex and a second vertex in a directed acyclic graph.

FIG. 2 illustrates an exemplary embodiment of a directed acyclic graph.

FIG. 3 illustrates the graph of FIG. 2 with an additional intermediate vertex.

FIG. 4 illustrates the graph of FIG. 2 with an additional edge between existing vertices.

FIG. 5 illustrates the graph of FIG. 2 with an edge between existing vertices deleted.

FIG. 6 is a block diagram view of an exemplary system for determining transitive closure between a first vertex and a second vertex in a directed acyclic graph

### DETAILED DESCRIPTION

Various embodiments are described herein to various apparatuses, systems, and/or methods. Numerous specific details are set forth to provide a thorough understanding of the overall structure, function, manufacture, and use of the embodiments as described in the specification and illustrated in the accompanying drawings. It will be understood by those skilled in the art, however, that the embodiments may be practiced without such specific details. In other instances, well-known operations, components, and elements have not been described in detail so as not to obscure the embodiments described in the specification. Those of ordinary skill in the art will understand that the embodiments described and illustrated herein are non-limiting examples, and thus it can be appreciated that the specific structural and functional details disclosed herein may be representative and do not necessarily limit the scope of the embodiments, the scope of which is defined solely by the appended claims.

Reference throughout the specification to “various embodiments,” “some embodiments,” “one embodiment,” or “an embodiment,” or the like, means that a particular feature, structure, or characteristic described in connection with the embodiment is included in at least one embodiment. Thus, appearances of the phrases “in various embodiments,” “in some embodiments,” “in one embodiment,” or “in an embodiment,” or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation given that such combination is not illogical or non-functional.

As noted above, known methods for storing the transitive closure of a directed acyclic graph and for finding paths between two vertices within the graph are inefficient and can be improved upon. As used herein and as known in the art, a directed graph is a graph in which each edge (connection between two vertices) has a tail and a head (i.e. a direction). The vertex at the tail of an edge is referred to herein as an ancestor vertex, and the vertex at the head of an edge as a descendant vertex. A vertex without any descendants is referred to as a leaf vertex, and a vertex without any ancestors is referred to as a root vertex. An acyclic graph is a graph in which there is no path in which a single vertex is included twice (i.e., no path which cycles back upon itself).

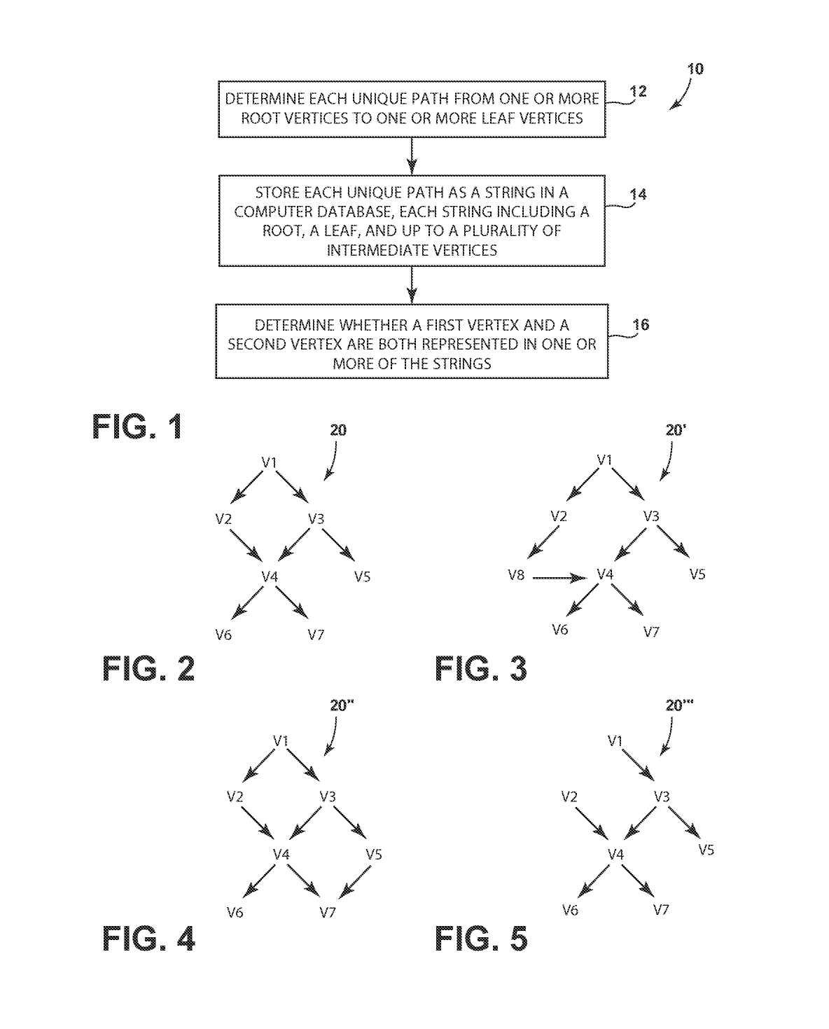

Referring to the drawings, in which like reference numerals refer to the same or similar elements, FIG. 1 is a flow chart illustrating a method 10 of determining paths from a first vertex to a second vertex in an acyclic directed graph. FIG. 2 illustrates an exemplary acyclic directed graph 20.

One or more steps of the method 10, along with other operations described herein and other known operations on a directed acyclic graph, may be implemented with a declarative programming language, in an embodiment. For example, but without limitation, such operations and the method 10 could be implemented with Python code.

The graph 20 and other graphs illustrated and described herein are for explanatory purposes only. Methods and operations according to this disclosure may be implemented on directed acyclic graphs of any size and in any technical field. Furthermore, methods and operations according to this disclosure are not limited to any particular type of data represented by a graph.

Referring to FIGS. 1 and 2, the method 10 may begin with a step 12 that includes determining each unique path from each root vertex to each leaf vertex in the graph 20. In the graph 20, V1 is the lone root vertex, and V5, V6, and V7 are leaf vertices. V1 is an ancestor of each of V2, V3, V4, V5, V6, and V7. V2 is an ancestor of V4, V6, and V7. V4 is a descendant of V1, V2, and V3. Of course, numerous other ancestor and descendant relationships exist in the graph 20, but the foregoing are noted merely for explanatory purposes for the terms “ancestor” and “descendant.”

Table 1 lists each unique path within the graph 20. The paths are arranged according to “path id” merely for ease of discussion. Each path id and corresponding path in Table 1 represents a path from a root vertex to a leaf vertex. All possible paths are included. Thus, Table 1 includes each unique path within the graph 20. In implementations of the method 10, path determinations may be made according to methods known in the art, in an embodiment. For example, path determinations may be made by a human user observing the graph 20, or by a processor executing a routine to determine each unique path within the graph 20.

TABLE 1

| path id | path |
|---|---|
| P1 | V1, V2, V4, V6 |
| P2 | V1, V2, V4, V7 |
| P3 | V1, V3, V4, V6 |
| P4 | V1, V3, V4, V7 |
| P5 | V1, V3, V5 |

Once each unique path in the graph 20 is determined, the method 10 may further include a step 14 including storing each path as a respective array in a computer database. The storing step may be performed by a processor operably coupled with the database, in an embodiment. Because each array may represent a complete path, each array may include a root, a leaf, and up to a plurality of intermediate vertices in a path between the root and the leaf. An array representing a path within a graph may be referred to herein as a path array. The collection of stored arrays in the database may be referred to herein as a path table. A given vertex may be represented by the same character or set of characters in all path arrays, in an embodiment. Path arrays may be oriented according to the order in which vertices are reached when moving from root to leaf—i.e., with ancestor vertices appearing before (with a lower index than, or to the left of) descendant vertices. In another embodiment, path arrays may be oriented in the opposite order—i.e., with descendant vertices appearing before (with a lower index than, or to the left of) ancestor vertices.

In an embodiment, the database in which the arrays are stored may be a modern document store that supports array fields, searching on the stored arrays, and multi-key indexes. Such a database, in conjunction with the methods and operations described herein, may provide improved efficiency over known methods (particularly methods involving SQL tables), both in finding edges between any two vertices and in maintaining the database representation of the graph.

Once each path in the graph 20 is stored as an array, the method 10 may continue to a step 16 including determining whether the first vertex and the second vertex are both represented in one or more of the stored arrays (i.e., determining the transitive closure of the first vertex and the second vertex). This determination may be made by a processor operatively coupled with the database, in an embodiment, and may be implemented through a search of the database by the processor. The determination may return each array (i.e., each path) in which both vertices appear, the number of arrays in which both vertices appear, or some other output. For example, in an embodiment of the step 16, the transitive closure of V1 and V7 may be found. Table 2 illustrates a result of a search for such transitive closure and includes all paths including V1 and V7 in the graph 20.

TABLE 2

| path id | path |
|---|---|
| P2 | V1, V2, V4, V7 |
| P4 | V1, V3, V4, V7 |

An array-based representation of the graph also enables numerous other operations for retrieving graph-related information. For example, a simple search to derive all paths containing a given vertex Vx (where x=1, 2, 3, . . . ) may be performed. Table 3 shows all paths including vertex V2 in the graph 20.

TABLE 3

| path id | path |
|---|---|
| P1 | V1, V2, V4, V6 |
| P2 | V1, V2, V4, V7 |

The array-based representation and storage of the graph 20 according to this disclosure enables efficient determination of transitive closure for any number of vertices. For example, in addition to the single-vertex and two-vertex searches noted above, a search for paths may be formed to include any number of specific intermediate vertices. For example, a search for a path that includes V1, V5 and V7 would result in an empty set. In another example, a search for a path that includes V1, V2, and V7 would return one path, as shown in Table 4.

TABLE 4

| path id | path |
|---|---|
| P2 | V1, V2, V4, V7 |

In addition to a number of particular vertices, array-based representation and storage according to this disclosure enables culling of search results based on the relationships between the searched vertices. When determining transitive closure, the order of vertices in an array (i.e., relative indices of vertices) may be considered in a search, in embodiments in which the relationship between vertices (i.e., which vertex in a search is the ancestor, which a descendant, and/or which intermediate) is relevant. In other embodiments in which the relationship between vertices is not relevant, and therefore in which all paths containing given vertices are desired, the order of vertices in an array may be ignored. For example, a search for paths including V7 and V1 would give the same result as Table 2 if order is not important. If order is important, no results would be found in such a search for the graph 20. Furthermore, if searched vertices are not root and leaf vertices, a search may be limited to only intermediate vertices and unique sets, in an embodiment.

Determining Descendants and Ancestors.

As mentioned above, numerous operations, in addition to finding transitive closure, are enabled by array-based graph representation and storage according to this disclosure. For example, instead of full transitive closure, just ancestors or descendants of a given vertex may be found. An algorithm to find only descendants may be simply achieved by extracting parts of one or more paths to the right of (i.e., having a higher array index than) the desired vertex and limiting the results to unique paths, in an embodiment. Table 5 shows paths through the graph 20 including vertex V2, limited to V2 and its descendants.

TABLE 5

| path id | path |
|---|---|
| P1 | V2, V4, V6 |
| P2 | V2, V4, V7 |

Similarly, the ancestors of vertex Vx may be found by following the same procedure for vertices to the left of (i.e., having a lower index than) the desired vertex. Table 6 shows paths including vertex V2, limited to V2 and its ancestors.

TABLE 6

| path id | path |
|---|---|
| P1, P2 | V1, V2 |

Still further, ancestors and/or descendants of a given vertex within a certain number of edges (i.e. a given path length) may be found. An algorithm to limit the results to include only descendants less than a certain path length may be simply by extracting parts of the path to the right of (i.e., having a higher array index than) a desired vertex to a maximum number of vertices and limiting the results to the unique set. Table 7 shows paths including vertex V2 and its descendants with a path length of 2.

TABLE 7

| path id | path |
|---|---|
| P1, P2 | V2, V4 |

Similarly, the ancestors of vertex Vx up to a limited path length may be found by following the same procedure to the left of the vertex Vx.

In addition to operations to find paths including a given set of vertices, an array-based representation and storage of the graph 20 enables efficient implementation of a number of graph maintenance operations. For example, operations for adding a vertex, adding an edge between known vertices, deleting an edge, and deleting a vertex may be implemented.

Adding a Vertex.

Since all vertices are accessible from themselves, addition of a single vertex with no relationship to the rest of the graph may include adding a single path array (including only the new vertex) to the path table. Adding a vertex that becomes a root or leaf vertex may additionally include adding one or more edges as set forth below.

Adding an Edge.

Adding an edge between two existing vertices (i.e., in which a first existing vertex becomes an ancestor of the second existing vertex) may include deleting each array in which the first vertex was a leaf vertex, deleting each array in which the second vertex was a root vertex, and adding an array for each unique path including the new edge.

For example, if the previously-unconnected vertex becomes an intermediate vertex (i.e., having an ancestor edge and a descendant edge), maintenance may include adding the new edges between the vertex and its ancestor and the vertex and its descendant as set forth above and deleting the edge between the ancestor and the descendant as set forth below. For example, a vertex V8 may be added to and connected to the graph 20, resulting in the modified graph 20′ of FIG. 3, the paths of which are shown in Table 8 below.

TABLE 8

| path id | path |
|---|---|
| P1′ | V1, V2, V8, V4, V6 |
| P2′ | V1, V2, V8, V4, V7 |
| P3 | V1, V3, V4, V6 |
| P4 | V1, V3, V4, V7 |
| P5 | V1, V3, V5 |

It should be noted that path ids of the form Px′ are modified from their original form in Table 1. Furthermore, it should be noted that, rather than amending an array, the array to be amended may be deleted, and a new array added, in an embodiment.

In another example, adding edges between existing edges that are otherwise connected within the graph, such as from V5 to V7, yields the graph 20″ of FIG. 4. The addition of the edge may include deleting each array in which V5 was a leaf (P5) and each array in which V7 was a root (none) and adding an array for each unique path through V5 and V7 (new path P6). Table 9 illustrates the resulting path table.

TABLE 9

| path id | path |
|---|---|
| P1 | V1, V2, V4, V6 |
| P2 | V1, V2, V4, V7 |
| P3 | V1, V3, V4, V6 |
| P4 | V1, V3, V4, V7 |
| P6 | V1, V3, V5, V7 |

Deleting an Edge.

Deleting an edge between an ancestor and a descendant may involve deleting each array including the deleted edge, adding a new array for each unique path including the former ancestor if the former ancestor is a leaf vertex following the deleting, and adding an array for each unique path including the former descendant vertex if the former descendant vertex is a root vertex following the deleting. For example, FIG. 5 illustrates a modified graph 20′″ with the edge from V1 to V2 deleted. To delete the edge, each array including the edge must be deleted (P1, P2), each path in which V1 is a leaf must be added (none), and each path in which V2 is a root must be added (new paths P7, P8). Table 10 illustrates the resulting path table.

TABLE 10

| path id | path |
|---|---|
| P3 | V1, V3, V4, V6 |
| P4 | V1, V3, V4, V7 |
| P5 | V1, V3, V5 |
| P7 | V2, V4, V6 |
| P8 | V2, V4, V7 |

Deleting a Vertex.

Deleting a vertex may involve deleting each edge including the vertex, as set forth above, and deleting each remaining array in which the vertex is represented (i.e., as an unconnected vertex).

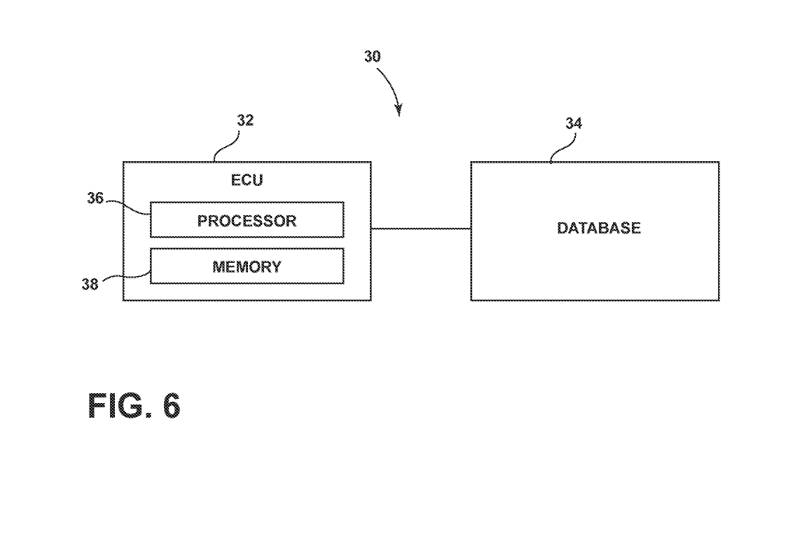

FIG. 6 is a block diagram view of an exemplary system 30 for determining transitive closure between a first vertex and a second vertex in an acyclic directed graph. The system 30 may be configured to perform the method 10 and one or more other methods and operations described herein, in an embodiment.

The system 30 may comprise an electronic control unit (ECU) 32 in communication with a database 34. The ECU 32 may comprise a processor 36 and a memory 38. The memory 38 may be configured to store instructions embodying one or more steps of the method 10, one or more other methods or operations described herein, and/or further methods and operations. The processor 36 may be in communication with the memory 38 and configured to execute the instructions to perform one or more steps of the method 10, one or more of the other methods and operations described herein, and/or further methods and operations.

In an embodiment, the database 34 may store a representation of a graph as a plurality of arrays, each array containing a representation of a path through the graph, in an embodiment. Each array may represent a unique path, in an embodiment. The database 34 may also store the data represented by the vertices of the graph, in an embodiment. The database 34 may be a modern document store that supports array fields, searching on the stored arrays, and multi-key indexes, in an embodiment.

The database 34 may be in communication with the ECU 32 over the internet, in an embodiment. Thus, the database 34 may be in the form of cloud storage or may be otherwise remote from the ECU 32. In another embodiment, the ECU 32 may be in communication with the database 34 over a local area connection. In yet another embodiment, the ECU 32 may form part of the same device or apparatus as the database 34, and the database 34 and ECU 32 may share processing or memory resources.

The techniques embodied in the method 10 and the system 30 may advantageously enable efficient determination of paths including two or more vertices in a directed acyclic graph. In particular, paths including three or more given vertices may be determined more efficiently than with known methods and systems. In addition, all paths between vertices may be efficiently determined (i.e., not simply whether any path exists). In addition, all ancestor and/or descendant paths may be determined, rather than just sets of vertices.

Although a number of embodiments have been described above with a certain degree of particularity, those skilled in the art could make numerous alterations to the disclosed embodiments without departing from the sprit or scope of this disclosure. For example, all joinder referenced (e.g., attached, coupled, connected, and the like) are to be construed broadly and may include intermediate members between a connection of elements and relative movement between elements. As such, joined references do not necessarily infer that two elements are directly connected and in fixed relation to each other. It is intended that all matter contained in the above description or shown in the accompanying drawings shall be interpreted as illustrative only and not limiting. Changes in detail or structure may be made without departing from the spirit of the invention as defined in the appended claims.

Any patent, publication, or other disclosure material, in whole or in part, that is said to be incorporated by referenced herein is incorporated herein only to the extent that the incorporated materials does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

What is claimed is:

1. A method for determining paths including a first vertex and a second vertex in an acyclic directed graph, the method comprising:
determining a plurality of paths from one or more root vertices in the graph to one or more leaf vertices in the graph;
storing a representation of each of the plurality of paths as a respective array in a computer database, each respective array comprising a respective root, a respective leaf, and up to a plurality of intermediate vertices; and
determining whether the first vertex and the second vertex are both represented in one or more of the arrays.

2. The method of claim 1, further comprising determining each array in which the first vertex and the second vertex are both represented.

3. The method of claim 1, further comprising determining whether a third vertex, the first vertex, and the second vertex are all represented in one or more of the arrays.

4. The method of claim 3, further comprising determining each array in which the first vertex, the second vertex, and the third vertex are all represented.

5. The method of claim 1, wherein the order of vertices in one of the plurality of arrays is the same as the order of vertices when progressing from a root to a leaf in the path represented by the array.

6. The method of claim 1, further comprising determining descendants of a third vertex by determining each array in which the third vertex is represented and extracting portions of each such array to the right of the third vertex.

7. The method of claim 1, further comprising adding a new leaf vertex to the graph by:
determining an ancestor vertex in the graph to which the new leaf vertex connects;
adding a new array including the new leaf vertex and the ancestor vertex if the ancestor vertex was not a leaf vertex before the addition of the new leaf vertex; and
amending each array containing the ancestor vertex to also include the new leaf vertex if the ancestor vertex was a leaf vertex before the addition of the new leaf vertex.

8. The method of claim 1, further comprising deleting an edge from a third vertex to a fourth vertex in which the third vertex is an ancestor of the fourth vertex by:
deleting each array that includes the edge;
adding an array for each unique path including the third vertex if the third vertex is a leaf vertex following the deleting; and
adding an array for each unique path including the fourth vertex if the fourth vertex is a root vertex following the deleting.

9. The method of claim 1, further comprising adding an edge from a third vertex to a fourth vertex in which the third vertex is an ancestor of the fourth vertex by:
adding an array for each unique path including the edge;
deleting each array in which the third vertex was a leaf vertex before the adding; and
deleting each array in which the fourth vertex was a root vertex before the adding.

10. A system for determining paths including a first vertex and a second vertex in an acyclic directed graph, the system comprising:
a database storing a representation of an acyclic directed graph, the representation comprising a plurality of paths from one or more root vertices in the graph to one or more leaf vertices in the graph, each of the plurality of paths stored as a respective array in the database, each respective array comprising a respective root, a respective leaf, and up to a plurality of intermediate vertices; and
an electronic control unit (ECU) in communication with the database, the ECU comprising:
a memory configured to store instructions; and
a processor configured to execute the instructions to search the database to determine whether the first vertex and the second vertex are both represented in one of said plurality of arrays.

11. The system of claim 9, wherein the ECU is in communication with the database through the internet.

12. The system of claim 9, wherein the ECU is in communication with the database through a local area connection.
